(19) United States
(12) Patent Application Publication
(10) Pub. No.: US 2011/0283657 A1
(43) Pub. Date: Nov. 24, 2011

(54) Pre-Cast Blocks For Use In Column Construction

(76) Inventors: David Barrett, Selinsgrove, PA (US); Derek Zimmerman, Mifflinberg, PA (US); David Jacobson, Liberty Township, OH (US); Randy Quaintance, York, NE (US); John C. Purvis, Cary, NC (US)

(21) Appl. No.: 13/030,021

(22) Filed: Feb. 17, 2011

Related U.S. Application Data
(60) Provisional application No. 61/305,289, filed on Feb. 17, 2010.

(51) Int. Cl. E04C 3/34; B29C 41/22; B29C 33/38; E04B 1/04; E04B 1/02

(52) U.S. Cl. 52/834; 52/745.17; 52/742.14; 264/219; 264/74

(57) ABSTRACT

A decorative column comprising a rigid center post, a plurality of pre-cast pieces with each piece having a hole extending therethrough so the pre-cast piece slides onto the center post and remains in place on the center post. Each pre-cast piece being stacked upon another pre-cast piece, the pre-cast pieces being of a predefined shape, and a compressible center core liner filling a portion of the hole of the pre-cast piece. The compressible center core including a cutout shape consistent with the cross sectional shape of the rigid center post thereby allowing passage of the center post through the compressible center core.

### RELATED APPLICATIONS

This application claims the benefit of the filing date of a provisional application with Ser. No. 61/305,289 which was filed on Feb. 17, 2010, the disclosure of which is incorporated herein by reference.

### TECHNICAL FIELD

The disclosed subject matter is directed to the production of pre-cast blocks for constructing modular columns.

### BACKGROUND

Decorative stone columns are widely used by homeowners and businesses for a variety of purposes such as the monuments at the entrance of a driveway, as supports between fence sections, as a base for a statue, and as pillars at the entrance to a building to name just a few uses. The construction of decorative stone columns normally requires the services of a skilled mason and the utilization of specialized masonry tools. The average individual does not typically have the necessary tools or requisite skill for constructing appropriate concrete forms or for completing decorative stone column construction. As a result, most decorative stone columns are usually constructed by a skilled mason and at a high cost. Producing a high quality, durable and aesthetically pleasing column at a reasonable cost can be accomplished with the assistance of modular column construction as is outlined below.

### SUMMARY

The present invention pertains to the construction of a decorative column and the method of producing the modular blocks that comprise the decorative column. The column comprises a rigid center post surrounded by a plurality of modular blocks. Each modular block has a hole extending through it so the block can fit onto the rigid center post and remain fixed in place on the post. Each modular block is stackable upon another block of similar construction. The present invention pertains to a method for not only producing the modular blocks with compressible inserts but also the erecting of a decorative column that is capable of accommodating ground heaving due to freezing temperatures and thermal expansion which is particularly important, for example, when the column is utilized to support fence sections.

The method comprises the steps of producing a flexible mold for forming the modular blocks, positioning a compressible insert into the mold, filling the open area created by the walls of the mold and the exterior surfaces of the compressible insert with a lightweight cementitious material, waiting for the cementitious material to cure and then removing the modular block from the flexible mold.

Once the modular blocks with the compressible inserts are removed from the mold they are positioned onto the rigid center post so that the compressible insert center opening is aligned with the rigid post and can slide down the post to either the ground or atop another modular block. The process of placing the modular blocks on the center post can be repeated as necessary to produce a decorative column of the desired height.

The compressible inserts are instrumental in reducing the weight of the modular blocks as the inserts are preferably comprised of materials such as EPS foam or cellular PVC to name but a few available options. In addition, the compressible inserts facilitate placement of the modular blocks on the rigid center post particularly for posts of a substantial height as the compressible and flexible material will not bind against the post as the blocks are lowered into position on the post.

### BRIEF DESCRIPTION OF DRAWINGS

FIG. 1 is a perspective view of a three rail fence constructed with modular columns;

FIG. 2 is a perspective view of a panel fence constructed with modular columns;

FIG. 3 is a perspective view of a center post of a modular column being constructed with pre-cast ornamental blocks;

FIG. 4 is a plan view of an embodiment of a pre-cast block without side slots utilized in a modular column;

FIG. 5 is a plan view of an embodiment of a pre-cast block with single dimension side slots utilized in a modular column;

FIG. 6 is a plan view of an embodiment of a block with dual dimension side slots utilized in a modular column;

FIG. 7 is a plan view of an embodiment of a block with single dimension side slots utilized in a modular column;

FIG. 8 is a cross sectional view of FIG. 2 revealing the interior features of a modular column;

FIG. 9 is a perspective view of an empty mold with a center post for forming a block for use in a modular column;

FIG. 10 is a perspective view of a mold showing a compressible insert surrounding the center post used for forming a block for use in a modular column;

FIG. 11 is a perspective view of a mold showing the addition of a cementitious material to the open area of the mold for forming a block for use in a modular column; and

FIG. 12 is a perspective view of a mold showing the cementitious material leveled at the top of the mold for purposes of forming a block for use in a decorative modular column.

### DETAILED DESCRIPTION

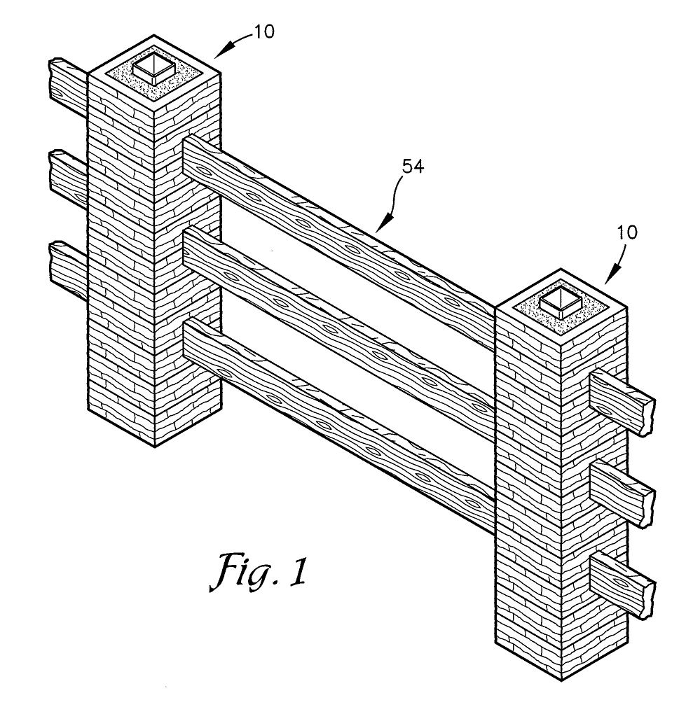

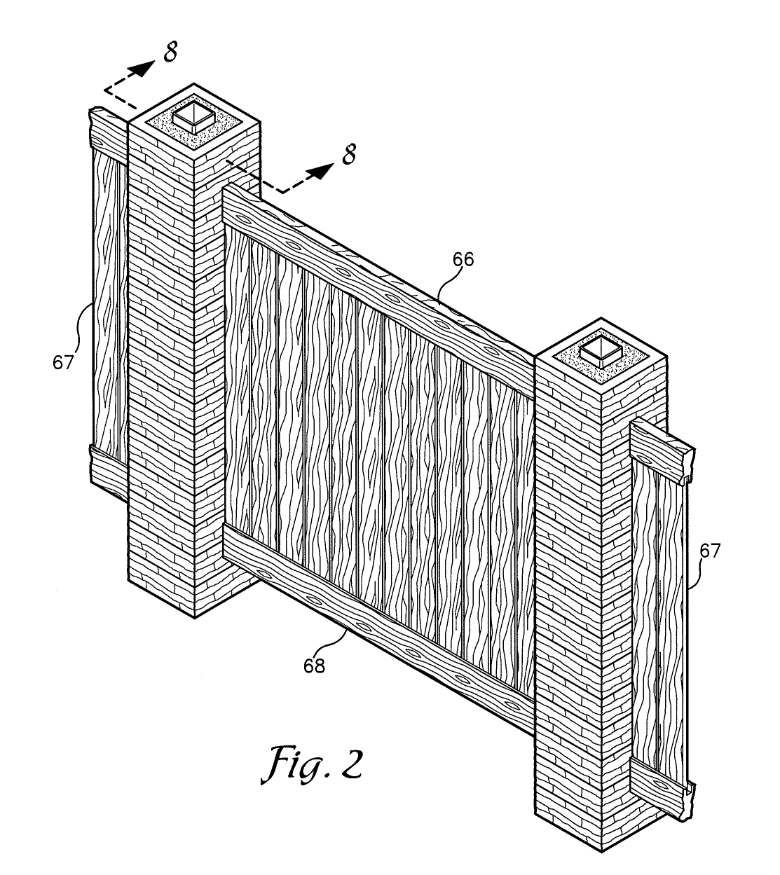

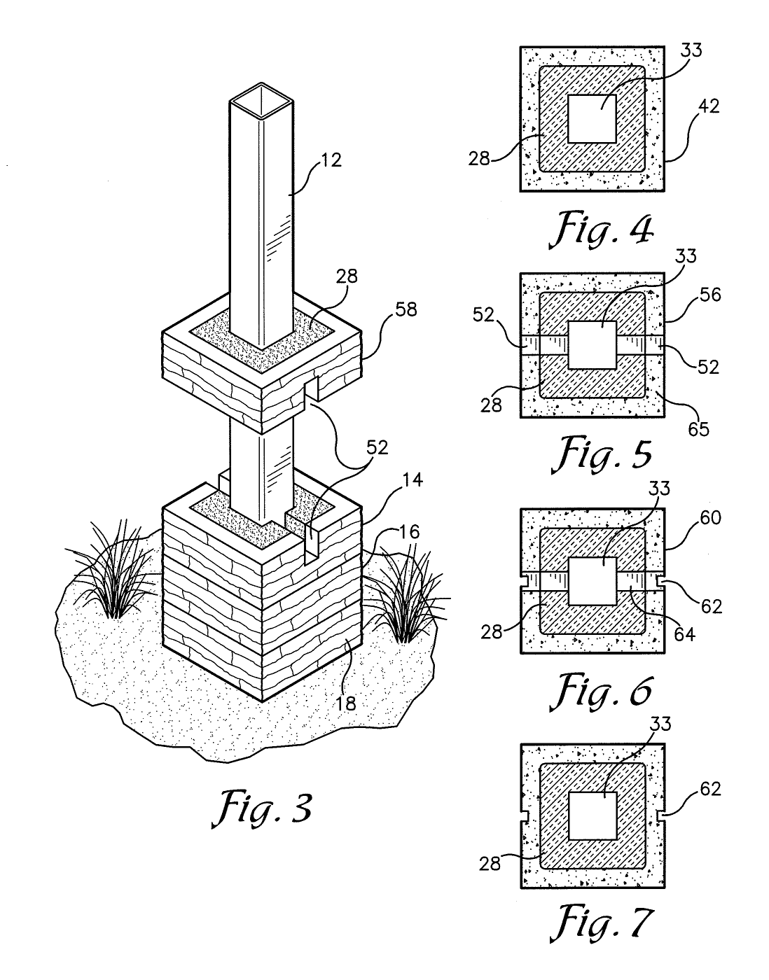

Referring now to the drawings wherein like reference numerals refer to similar of identical parts throughout the several views. FIG. 1 reveals a fence section comprised of two modular columns 10 connected by fence rails 54. FIG. 3 details the process by which a modular block 58 is lowered being lowered into position over a post 12 onto several pre-cast blocks 14, 16, 18 already in position. Pre-cast blocks can be used to efficiently and with high aesthetic appeal produce columns 10 for various embodiments of a rail fence such as seen in FIG. 1 as well as for various embodiments of a panel fence such as seen in FIG. 2. Numerous other embodiments and uses of columns utilizing this modular pre-cast block technology are also contemplated and are only limited by the imagination.

The production of a pre-cast block 58 begins with the use of a flexible mold 20 such as one produced from silicone and as depicted in FIG. 9. The mold 20 includes four sides 22A, B, C and D a center post 24 as well as textured interior walls 26. The textured interior walls 26 are intended to replicate on the finished modular block a stone face including a desirable and contrasting coloration. Prior to the addition of any cementitious material into the mold 20 the textured interior walls are coated with a coloration mixture of mineral iron oxides, cement, water and an acrylic modifier. The coating is applied consistent with the stone facing molded into the interior walls 26 so as to give the impression that the stone faces are of varying color as might be created by a mason using natural stone. Varying the mineral iron oxides content allows different colors to be formulated to satisfy customer preferences. This coloration mixture may be hand applied to specified portions of the interior wall. Alternatively, automated techniques may also be employed such as the use of robotic systems to apply the coloration mixture.

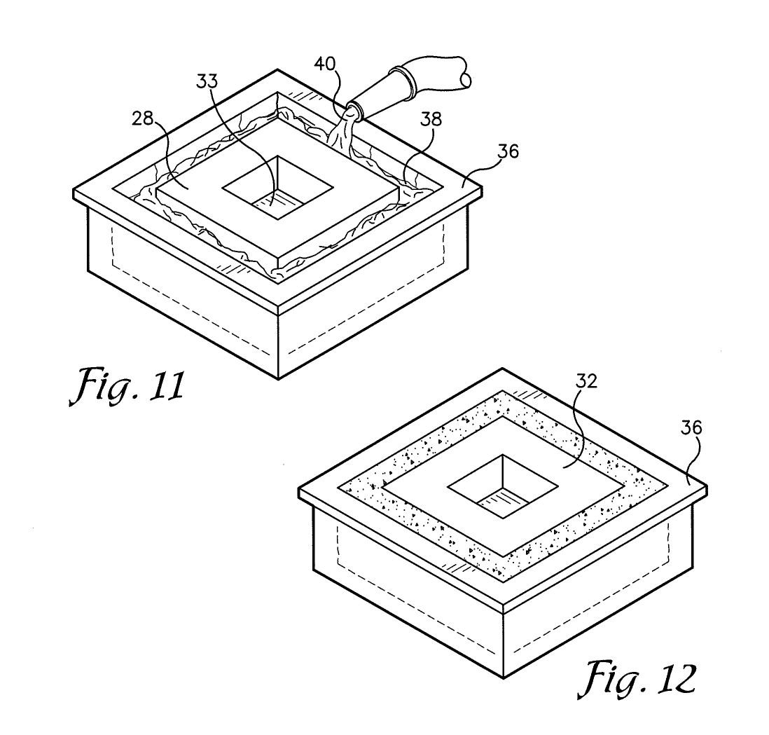

Once the subset of the textured interior walls 26 are coated with the above referenced mixture a compressible insert 28 is positioned over the center post 24 as shown in FIG. 10. The compressible insert 28 is lightweight, and preferably comprised of materials such as EPS foam or cellular PVC. The insert 28 includes an upper surface 32, and creates an interior space 33 that will prevent the intrusion of cementitious material and also includes a plurality of exterior walls 34. The insert upper surface 32 is preferably at the same elevation and not above the upper surface 36 of the textured interior walls 26.

Once the compressible insert 28 is secured in position over the center post 24, the open space 38 between the mold walls 26 and the exterior walls 34 of the compressible insert 28 is filled with a cementitious material 40 as seen in FIG. 11. The cementitious material 40 is preferably a light weight wet cement that readily flows to fill the open space 38. An exemplary mixture of cementitious material would comprise an expanded slate lightweight concrete, such as Stalite™, a dry pigment, aggregates and water combined to form a flowable, lightweight mixture.

Once the open space 38 is completely filled the mold 20 is vibrated to remove voids from the cementitious material 40, allow for settling and to facilitate the movement of the coloration mixture painted onto the mold interior walls 26 into the cementitious material 40 instead of remaining at the surface thereby giving a three dimensional penetration of the coloration mixture into the block and improving the weatherability of the block's surface coloration. In addition, as best seen in FIG. 12, the cementitious material 40 is leveled at the upper surface 36 to create a smooth even surface that facilitates the stackability of the blocks when the cement is cured.

In about twelve hours the cementitious material is fully cured and the block, along with the compressible insert, can be removed from the mold 20. Manipulation of the flexible mold 20, either manually by overturning the mold and popping out the block as is well known in the art, or by injection of air into an orifice in the mold bottom effectively inverting the silicone mold, will facilitate release of the block from the mold 20. Because the cementitious material 40 permeates the pores of the exterior walls 34 of the compressible insert 28, the insert is securely bound to the cementitious material and will not separate during use.

As seen in FIGS. 4 through 7, alternative embodiments of the block may be cast in the mold 20 with or without slots. FIG. 4 reveals a standard block 42 without slots that would properly be employed, for example, as shown at the lowermost block 18 in the column in FIG. 3. This lowermost slotless block 18 would typically be employed in a column utilizing between one and four fence rails, such as exemplified in FIG. 1.

An alternative block embodiment as depicted in FIG. 5 reveals a block 50 with slots 52 on opposed sides of the compressible insert 28. These opposing slots 52 serve to hold rails 54 in position as is best seen in FIG. 1. FIG. 3 also serves to highlight how the slot 52 of block 58 integrates with the slot and block 14 positioned immediately below it in the column to create an opening for securing the rail 54 in position. It will be readily apparent to one versed in the construction of columns that the placement of the slots 52 in a modular block 10 may be offset by 90 degrees, instead of 180 degrees, should a block be needed for a corner column with fence rails extending outwardly at 90 degrees instead of 180 degrees. In addition, a block may have only a single slot 52 should a column be needed that is adjacent a building or other structure and the rails need only extend in a single direction.

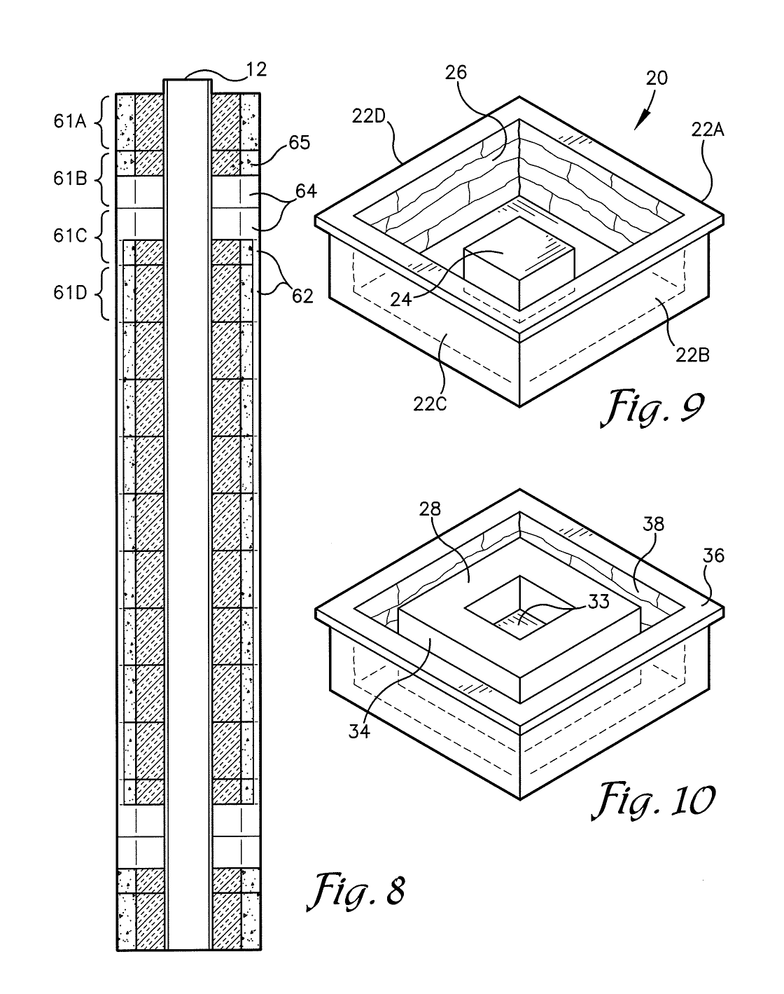

FIG. 6 depicts a third embodiment of a block 60 that is utilized in the construction of a panel fence such as that shown in FIG. 2. The narrower and shorter slot 62 serves to secure in place the edge of the entire height of the fence panel 67. The configuration of this slot 62 can also be viewed in cross section in FIG. 8 which shows four separate blocks 61A, 61B, 61C and 61D positioned at the top of the column. Block 61A serves as a capping block and includes no slots since the fence panel does not extend upwardly to that height. Block 61B includes an upper exterior surface 65 with no slot and a lower portion with a slot 64. The slot 64 on block 61B, in conjunction with slot 64 in block 61C serves to secure one end of the upper rail 66, as best seen in FIG. 2, in position within the column. Block 61C also includes a small slot 62 that is intended to facilitate securing the top portion of the panel 67 in position. Finally, block 61D includes only a small slot 62 but no larger slot 64, such as that depicted in FIG. 7. The configuration of block 61D is repeated on blocks lower in the column until reaching the lower rail 68 where a similar configuration of blocks is utilized to support the rail 68 and the panel 67 as seen at the top of the column with blocks 61B and 61C. The dimensions of the slots 62, 64 may be tailored to any preferred dimension during production to suit the specific dimensions of the fence rails 66, 68 and panels 67 that are being utilized. To produce slots of the desired dimension one or more inserts are positioned within the mold prior to introduction of the cementitious material 40 or the molds may have the inserts already included. Whether specifically designed into the mold for purpose of occluding the presence of the cementitious material or removable inserts are positioned within the mold 20, once the cementitious material 40 has been cured the slots are formed into the finished block and they are ready for column construction.

The various embodiments of the present invention may be utilized to create a structurally sound and aesthetically pleasing column that can stand alone or be incorporated into a fence of a wide range of configurations including rail fences or panel fences. The use of pre-cast blocks 58 with their aesthetically pleasing exterior surfaces, preconfigured slots and lightweight but structurally rigid material greatly facilitates the construction of the columns. Turning again to FIG. 3, a rigid center post 12 is placed into the ground or secured by some other means so that it stands in a substantially vertical orientation. The center post 12 is preferably a vinyl composition post because of its resistance to weathering and insects, but may be of any sturdy material such as wood, metal or concrete. Additionally, the center post 12 can be of a wide range of dimensions such as 5 inches square or 3 inches square. Alternatively a rectangular of circular configuration for the rigid center post 12 also may be employed. The center post 12 must, however, be of only slightly lesser dimensions than the hole dimension of the compressible insert 28 so that proper alignment of the pre-cast blocks on the modular column 10 can be accomplished.

As seen in FIG. 3, once the center post 12 is secured in a substantially vertical orientation, the central opening 33 of the pre-cast block's 58 compressible insert 28 is aligned over the center post 12. The first pre-cast block 18 to be installed is then moved onto the lowermost support surface which will either typically be a ground surface or a prepared level surface such as concrete. The process of placing additional pre-cast blocks on the column is greatly simplified with the use of a compressible insert 28. The compressible insert material is soft and pliable and therefore will not bind against the center post 12 because of interference between the insert 28 and the post 12. Moreover, as noted above, because of the light weight of the compressible insert and the fact that it occupies a significant percentage of the block interior volume that otherwise would be occupied by cementitious material 40 the pre-cast block weighs far less than a pre-cast block constructed without a compressible insert 28. The nominal weight of a pre-cast block greatly facilitates the construction of a decorative modular column as placement of a pre-cast block with a compressible insert onto a center post 12 requires lesser physical exertion than installation of blocks comprised entirely of cementitious material 40.

As further seen in FIG. 3, a multitude of modular blocks 14, 16, 18, 58 may be placed onto the rigid center post 12 to create a decorative column of any desired height depending upon how the columns is to be employed, for example, as a fence post, a support column or a mailbox stand. If building a fence rail column then, as previously discussed, slots 52, 62, 64 may be configured to satisfy the dimensional requirements of the fence rails and panels. Advantageously, no mortar need be placed between the pre-cast blocks to secure them in position as the blocks simply reside one atop the other creating a seamless textured stone exterior along the entire length of the column. Also advantageously, the compressible insert 28 greatly facilitates the resiliency and longevity of the decorative column 12 in areas where there is heaving of the ground due to the freeze-thaw cycle. Because of these compressible inserts 28, the pre-cast blocks can float on the center post 12 thereby avoiding the accumulation of tensile and compressive forces that can readily fracture hand crafted stone columns or even those with pre-cast blocks that are mortared and locked into fixed positions. For stone columns, such as those shown in FIG. 1, that are employed as fence columns, the thermal expansion of the fencing segments can produce significant lateral loads on the stone columns that can be absorbed by the compressible inserts 28 thereby avoiding damage to the stone columns through cracking of the column materials.

Those skilled in the art appreciate that variations from the specified embodiments disclosed above are contemplated herein and that the described embodiments are not limiting. The description should not be restricted to the above embodiments, but should be measured by the following claims.

We claim:

1. A decorative column comprising:
a center post;
a plurality of pre-cast blocks, each block having a hole extending therethrough so the pre-cast blocks slide onto the center post and remain in place on the center post, each pre-cast block being stacked upon another pre-cast block to achieve a desired column height; and
a compressible liner surrounding the hole of each pre-cast block, the hole within the compressible liner comprising a cross-sectional shape dimensionally consistent with the cross-sectional shape of the center post thereby allowing passage of the center post through the compressible liner.

2. A decorative column comprising:
a center post;
a plurality of pre-cast blocks, each pre-cast block having a hole extending therethrough so the pre-cast blocks slide onto the center post and remain in position on the center post; and
a flexible liner surrounding the hole of the pre-cast block and surrounding the rigid center post when in position on the center post, the flexible liner center core including a cutout shape consistent with the cross sectional shape of the center post thereby allowing passage of the center post through the flexible center core.

3. A method of constructing a decorative modular column, the method comprising;
constructing a mold for forming at least one block with a centralized opening wherein the mold includes a bottom panel with a centrally disposed riser post and a plurality of walls, each wall having a substantially horizontal upper surface;
positioning a compressible insert with an interior opening over the riser post, the compressible insert having a plurality of exterior surfaces, the plurality of walls of the mold and the plurality of exterior surfaces of the compressible insert forming an open space;
filling the open space with cementitious material and leveling the cementitious material flush with the substantially horizontal upper surface;
upon curing of the cementitious material, removing the at least one block from the mold and repeating the aforementioned sequence as required to obtain the requisite number of blocks to complete the decorative modular column;
positioning a rigid post in a substantially vertical orientation;
placing the compressible insert interior opening over the rigid post and positioning the modular block against either a ground surface or an adjacent block; and
repeating the placement of modular blocks onto the rigid post as necessary to construct a decorative modular column of a desired height.

4. A method of constructing a decorative modular column as in claim 3, wherein at least one of the plurality of mold walls includes a protrusion for forming a slot in the cementitious material of the modular block.

5. A method of constructing a decorative modular column as in claim 4, wherein the slot is configured to accommodate a fence rail.

6. A method of constructing a decorative modular column as in claim 4, wherein the slot is configured to accommodate an edge of a fence panel.

7. A method of constructing a decorative modular column as in claim 3, wherein the compressible insert material is selected from the group consisting of extruded polystyrene foam, expanded polystyrene foam, extruded polyproylene foam, cellulosic foam, polyurethane foam, cellular polyvinyl chloride, polymers of ethylene, propylene, vinyl acetate, diisocyanate, cellulose acetate and isobutylene.

8. A method of constructing a decorative modular column as in claim 3 where the cementitious material is comprised of a mixture of lightweight concrete, a dry pigment, aggregates and water.

9. A method of constructing a block for use in a modular column, the method comprising;
constructing a flexible mold for forming at least one modular block with a centralized opening wherein the mold includes a bottom panel with a riser post and a plurality of walls, each wall having a substantially horizontal upper surface;
positioning a compressible insert with an interior opening over the riser post, the compressible insert having a plurality of exterior surfaces, the plurality of walls of the mold and the plurality of exterior surfaces of the compressible insert forming an open space;
filling the open space between the plurality of walls of the mold and the plurality of the exterior surfaces of the compressible insert with cementitious material and leveling the cementitious material flush with the upper surface of the mold walls;
curing the cementitious material; and
removing the block from the mold.

10. A method of constructing a block for use in a modular column as in claim 9, including the application of a coloration mixture to the plurality of walls prior to the addition of cementitious material.

11. A method of constructing a block for use in a modular column as in claim 10, wherein the coloration mixture comprises mineral iron oxides, cement, water, and an acrylic modifier.
